(19) United States
(12) Patent Application Publication
(10) Pub. No.: US 2004/0136372 A1
(43) Pub. Date: Jul. 15, 2004

(54) Protecting data transmissions in a point-to-multipoint network

(76) Inventor: Dumitru Gruia, San Ramon, CA (US)

Correspondence Address: Alloptic, Inc., Suite 101, 2301 Armstrong Street, Livermore, CA, 94550, US

(21) Appl. No.: 10/340,280

(22) Filed: Jan. 10, 2003

(51) Int. Cl. H04L 12/28

(52) U.S. Cl. 370/390; 370/432

(57) ABSTRACT

Protecting downstream data transmissions in a point-to-multipoint network involves generating keys at both ends of the network and using the keys to chum and dechurn downstream data. Keys may be generated using seeds that are generated from the downstream data itself. For example, new seeds can be generated for each byte of downstream data and new keys can be generated from the seeds on a per-byte basis. In addition to generating keys on a per-word basis, a higher level of protection can be achieved by generating churning and dechurning keys on a per-ONU and/or a per-packet basis. In an embodiment, keys are generated at both the churning side and the dechurning side of the network in response to three different seed values, ONU-specific seed values, packet-specific seed values, and word-specific seed values. The ONU-specific, packet-specific, and word-specific seeds ensure a high level of unpredictability for the generated keys.

### FIELD OF THE INVENTION

The invention relates generally to broadband communications networks, and more particularly to protecting data transmissions in point-to-multipoint networks.

### BACKGROUND OF THE INVENTION

The explosion of the Internet and the desire to provide multiple communications and entertainment services to end users have created a need for a broadband network architecture that improves access to end users. One broadband network architecture that improves access to end users is a passive optical network (PON). A PON is a point-to-multipoint optical access network architecture that facilitates broadband communications between an optical line terminal (OLT) and multiple remote optical network units (ONUs) over a purely passive optical distribution network. A PON utilizes passive fiber optic splitters and couplers to distribute optical signals between the OLT and the remote ONUs.

FIGS. 1A and 1B represent the downstream and upstream flow of network traffic between an OLT 102 and three ONUs 104 in a PON. Although only three ONUs are depicted, more than three ONUs may be included in a PON. Referring to FIG. 1A, downstream traffic containing ONU-specific information blocks 106 is transmitted from the OLT. In an ATM-based PON or “APON” the information blocks are 53-byte cells and in an Ethernet-based PON or “EPON” the information blocks are variable-length packets. The downstream traffic is optically split by a passive optical splitter/coupler 110 into three separate signals that each carries all of the ONU-specific information blocks. In affect, the ONU-specific information blocks are “broadcast” to all of the ONUs. The information blocks that are intended for specific ONUs are then filtered by the ONUs and passed to the respective end-users while the information blocks that are not intended for the respective end-users are discarded. For example, information block 1 is passed to end-user 1, information block 2 is passed to end-user 2, and information block 3 is passed to end-user 3. Referring to FIG. 1B, the transmission of upstream traffic from the ONUs is synchronized so that none of the upstream information blocks 108 interfere with each other upon being combined at the splitter/coupler.

Because of the broadcast nature of PONs in particular and point-to-multipoint networks in general, it is possible to eavesdrop on downstream information blocks that are intended for the other ONUs. In order to prevent eavesdropping in a PON, downstream information blocks are often protected with ONU-specific encryption and decryption. For example, downstream data may be encrypted using ONU-specific keys that are generated at each ONU and passed upstream to the OLT. The OLT then encrypts downstream information blocks using the ONU-specific keys such that downstream information blocks can only be decrypted by the intended ONU. Because PON access networks are designed to provide high-speed network access, the encryption and decryption processes at the OLT and ONUs need to be accomplished at high rates of speed. One solution for encrypting and decrypting downstream data at acceptable rates involves “churning” the raw downstream data at the OLT and “dechurning” the churned downstream data at the ONUs. Churning is a hardware-based encryption technique that involves a memoryless transformation of plain-text to cipher-text and visa versa. In particular, churning involves a non-linear substitution scheme, whose function changes in response to a churning key.

Churning has been incorporated as a standard technique for APONs to protect against eavesdropping. The APON churning standard is described by the ITU-T in the Recommendation G.983.1. According to the ITU-T Recommendation G.983.1 (February 1998), churning keys are generated at the ONUs and then passed to the OLT in response to new key requests from the OLT. The churning keys are periodically changed (i.e., “at least 1 update per second per ONU” according to the Recommendation G.983.1) to prevent an eavesdropper from breaking the cipher-text. While changing the ONU-specific keys at least once per second does provide some barrier to eavesdropping, it is likely that advances in computer technology will make unauthorized eavesdropping easier to achieve.

In view of the broadcast nature of downstream data transmissions in point-to-multipoint networks, what is needed is a robust scheme for preventing unauthorized eavesdropping that is economical to implement and that can meet the speed requirements of leading edge access networks.

### SUMMARY OF THE INVENTION

Protecting downstream data transmissions in a point-to-multipoint network involves techniques for rapidly changing the keys that are used to churn and dechurn downstream data. A technique for protecting downstream data transmissions in a point-to-multipoint network involves generating keys at both ends of the network and using the keys to churn and dechurn downstream data. Because the keys are generated at both ends of the network, as opposed to being generated at one end of the network and passed to the other end, the keys can be changed at a higher frequency than other known techniques. In an embodiment, keys are generated using seeds that are generated from the downstream data itself. For example, new seeds are generated for each byte of downstream data and new keys are generated from the seeds on a per-byte basis. In addition to generating keys on a per-word basis, a higher level of protection can be achieved by generating churning and dechurning keys on a per-ONU and/or a per-packet basis. In an embodiment, keys are generated at both the churning side and the dechurning side of the network in response to three different seed values, ONU-specific seed values, packet-specific seed values, and word-specific seed values. The ONU-specific, packet-specific, and word-specific seeds ensure a high level of unpredictability for the generated keys.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A depicts the downstream flow of traffic from an OLT to multiple ONUs in a point-to-multipoint PON.

FIG. 1B depicts the upstream flow of traffic from multiple ONUs to an OLT in a point-to-multipoint PON.

FIG. 2 depicts example inputs to a key generator with a corresponding churning or dechurning key as an output.

FIG. 3 depicts an embodiment of a system for protecting downstream data transmissions in a point-to-multipoint network.

FIG. 4 depicts an example exchange of ONU-specific seed information between an OLT and an ONU.

FIG. 5 depicts an example Ethernet packet with a 16-bit packet-specific seed embedded into the preamble.

FIG. 6 depicts an example seed function circuit that has an input of one byte of unchurned data and an output of a two byte byte-specific seed.

FIG. 7 depicts a process flow diagram of a technique for protecting downstream data transmissions between an OLT and multiple ONUs in a point-to-multipoint network from the perspective of the OLT side (i.e., the churning side) of the network.

FIG. 8 is a process flow diagram of a technique for protecting downstream data transmissions between an OLT and multiple ONUs in a point-to-multipoint network from the perspective of the ONU side (i.e., the dechurning side) of the network.

FIG. 9 depicts an example sequence of per-byte processes from the perspective of the OLT side (i.e., the churning side) of a point-to-multipoint network.

FIG. 10 depicts an example sequence of per-byte processes from the perspective of the ONU side (i.e., the dechurning side) of a point-to-multipoint network.

FIG. 11 depicts a process flow diagram of a method for protecting data transmissions between a central node and multiple remote nodes in a point-to-multipoint network.

FIG. 12A depicts another process flow diagram of a method for protecting data transmissions between a central node and multiple remote nodes in a point-to-multipoint network.

FIG. 12B depicts another process flow diagram of a method for protecting data transmissions between a central node and multiple remote nodes in a point-to-multipoint network.

FIG. 13A depicts the churn logic as specified in the ITU-T Recommendation G.983.1.

FIG. 13B depicts the dechurn logic as specified in the ITU-T Recommendation G.983.1.

FIG. 13C depicts an expanded view of one of the churn/dechurn elements depicted in FIGS. 13A and 13B as specified in the ITU-T Recommendation G.983.1.

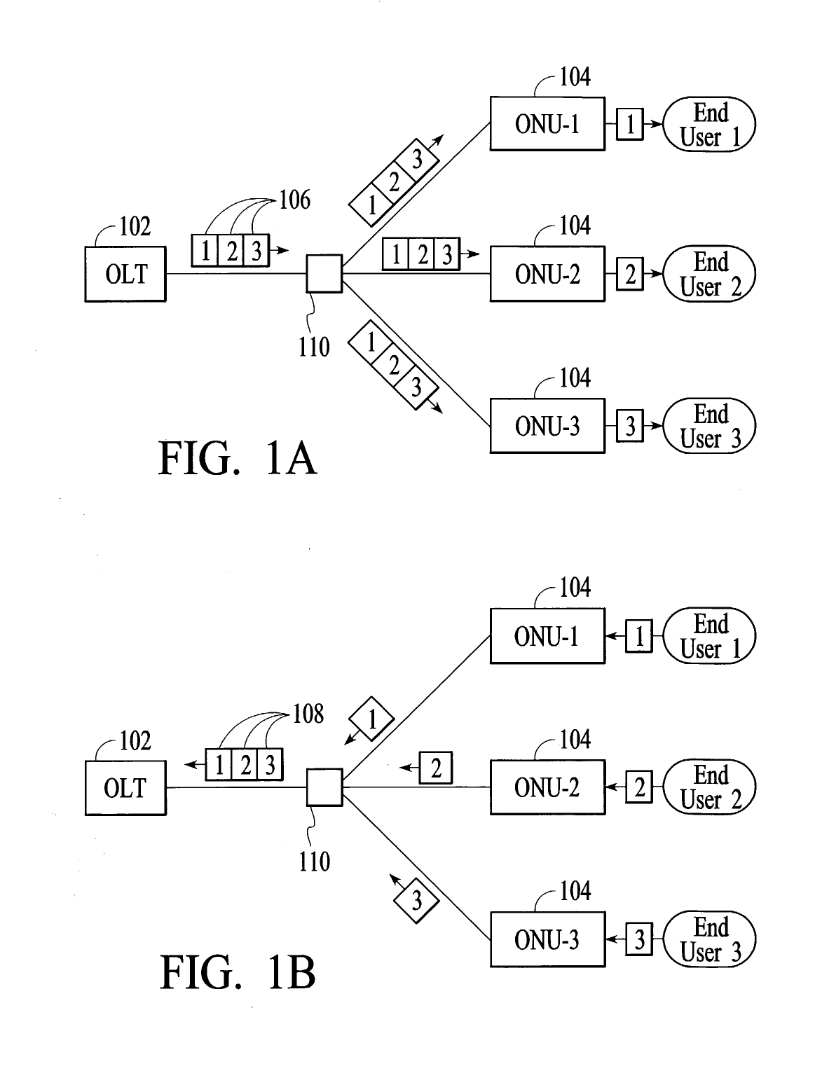

### DETAILED DESCRIPTION OF THE INVENTION

Protecting downstream data transmissions in a point-to-multipoint network involves techniques for rapidly changing the keys that are used to churn and dechurn downstream data. A technique for protecting downstream data transmissions in a point-to-multipoint network involves generating keys at both ends of the network and using the keys to churn and dechurn downstream data. Because the keys are generated at both ends of the network, as opposed to being generated at one end of the network and passed to the other end, the keys can be changed at a higher frequency than other known techniques. In an embodiment, keys are generated using seeds that are generated from the downstream data itself. For example, new seeds are generated for each byte of downstream data and new keys are generated from the seeds on a per-byte basis. In addition to generating keys on a per-word basis, a higher level of protection can be achieved by generating churning and dechurning keys on a per-ONU and/or a per-packet basis. In an embodiment, keys are generated at both the churning side and the dechurning side of the network in response to three different seed values, ONU-specific seed values, packet-specific seed values, and word-specific seed values. The ONU-specific, packet-specific, and word-specific seeds ensure a high level of unpredictability for the generated keys.

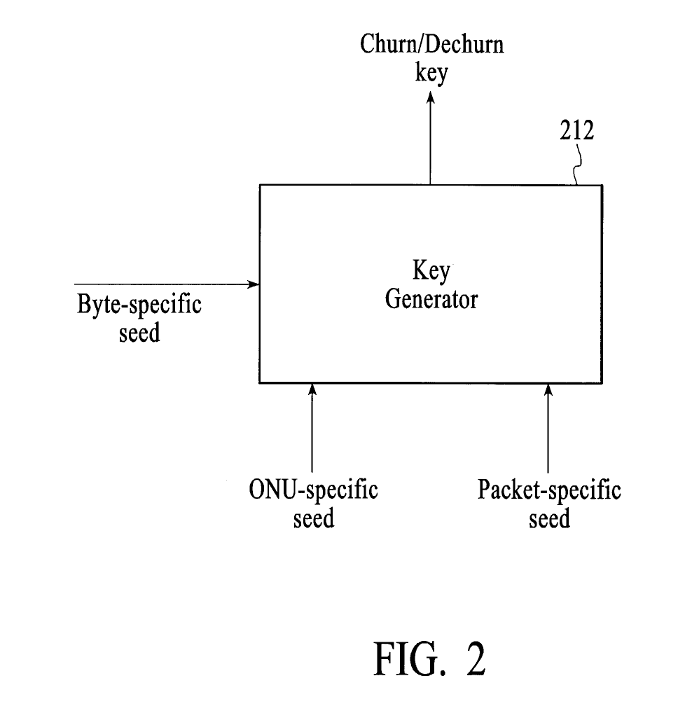

In an embodiment, churning and dechurning keys are generated at both ends of a point-to-multipoint network in response to ONU-specific seeds, packet-specific seeds, and byte-specific seeds. FIG. 2 depicts example inputs to a key generator 212 with a corresponding churning or dechurning key as an output. As is described in more detail below, the ONU-specific seeds are values that are specific to individual ONUs (or groups of ONUs in multicast applications), the packet-specific seeds are values that are specific to individual packets (i.e., Ethernet packets in an EPON), and the byte-specific seeds are values that are specific to a particular byte of data within a packet. When preparing data for downstream transmission from an OLT, the churn keys are generated using ONU-specific seeds, packet-specific seeds, and word-specific seeds. The ONU-specific seeds change depending on the intended ONU of each downstream packet, the packet-specific seeds change with each new downstream packet, and the byte-specific seeds change with each new byte of downstream data. When receiving a downstream data transmission at a particular ONU, dechurn keys are generated using ONU-specific seeds, packet-specific seeds, and word-specific seeds. At the ONU side, the ONU-specific seed is known at the ONU and does not change, packet-specific seeds change with each received downstream packet, and the byte-specific seeds change with each received byte of downstream data.

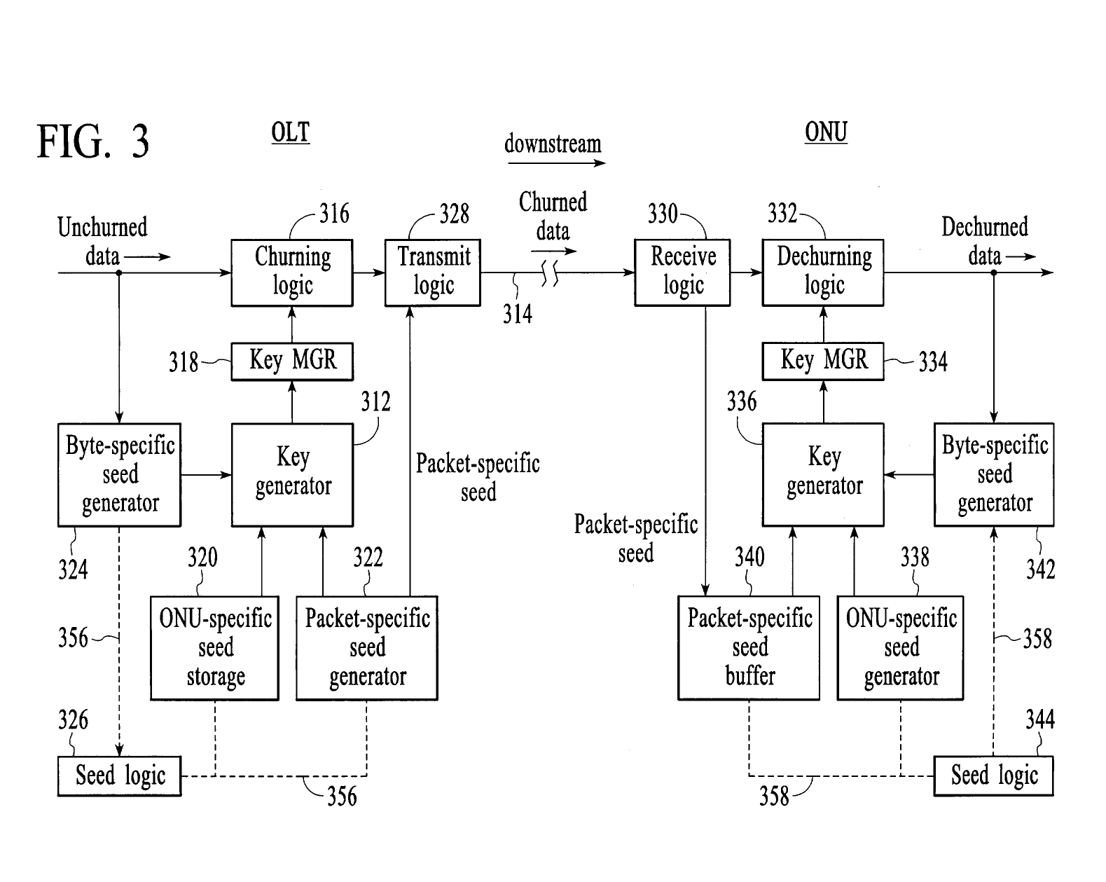

An embodiment of a system for protecting downstream data transmissions in a point-to-multipoint network is depicted in FIG. 3. In the embodiment of FIG. 3, the point-to-multipoint network is a PON that transmits data downstream from an OLT to multiple ONUs via an optical link 314. On the OLT side of the network, the system includes churning logic 316, a key manager 318, a key generator 312, ONU-specific seed storage 320, a packet-specific seed generator 322, a byte-specific seed generator 324, seed logic 326, and transmit logic 328. On the ONU side of the network, the system includes receive logic 330, dechurning logic 332, a key manager 334, a key generator 336, an ONU-specific seed generator 338, a packet-specific seed buffer 340, a byte-specific seed generator 342, and seed logic 344. Although only a single ONU is depicted on the ONU side of the network, it should be understood that the point-to-multipoint network includes multiple ONUs. The individual elements of the system are described below followed by an operational description of the system.

OLT Side

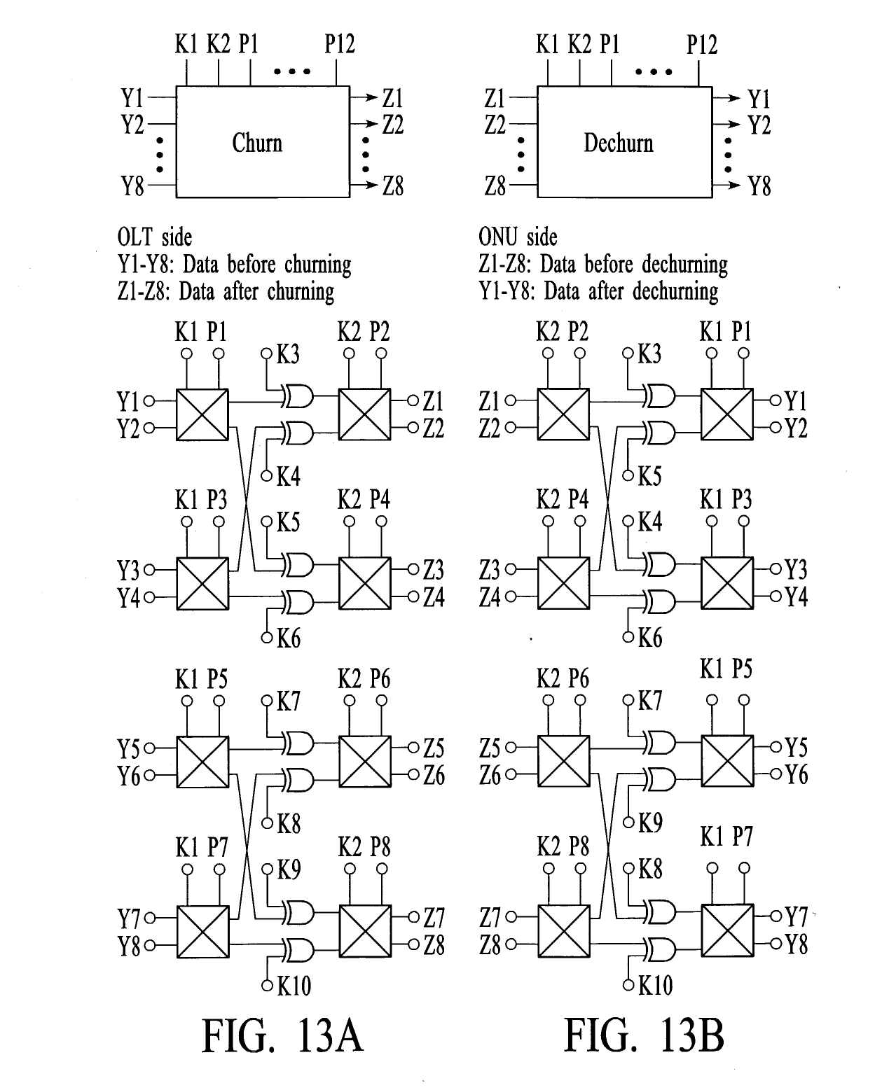

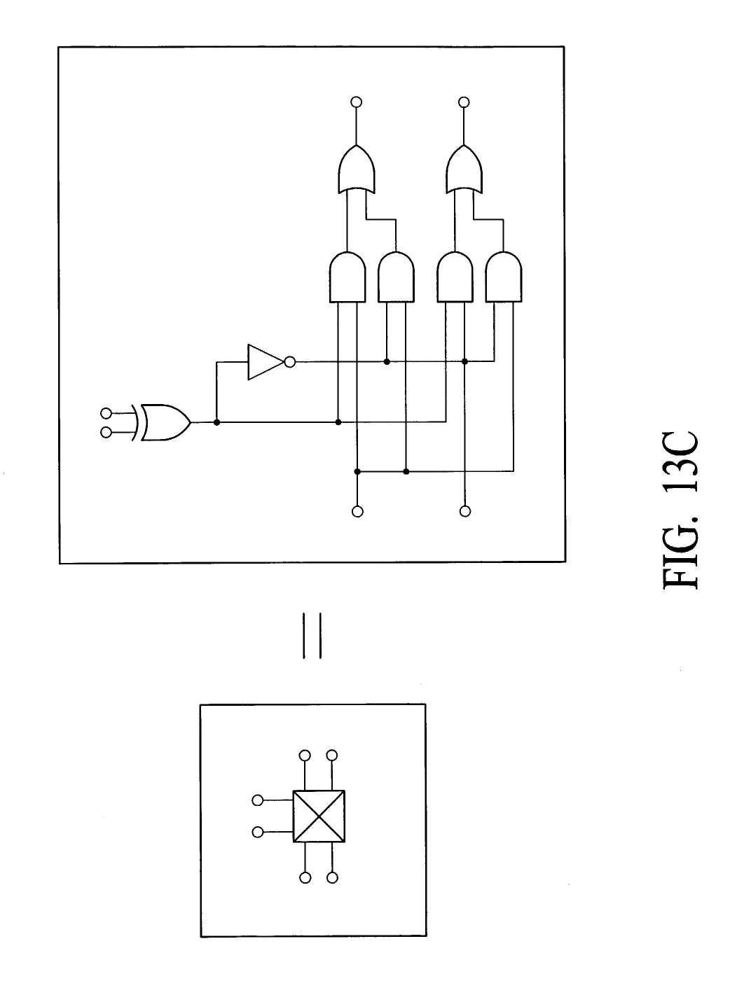

With reference to the OLT side of the system, the churning logic 316 performs the churning of downstream data. In an embodiment, the churning logic performs the churning function that is specified in the ITU-T Recommendation G.983.1. For example purposes, the churning logic that is specified in the ITU-T Recommendation G.983.1 is described below with regard to FIGS. 13A-13C. As depicted in FIG. 3, the churning logic receives unchurned downstream data and churning keys and outputs churned data. In an embodiment, the churning logic is embodied in an application specific integrated circuit (ASIC).

The key manager 318 on the OLT side of the system provides the keys to the churning logic 316. In an embodiment, the key manager provides a new key to the churning logic on a per-word basis. The key manager receives keys from the key generator 312 and may include memory for buffering keys before they are provided to the churning logic. As is described below, the buffering of keys may be used to implement an offset between key generation and churning.

The key generator 312 on the OLT side of the system generates new keys in response to various seeds. In the embodiment of FIG. 3, the key generator generates keys in response to seeds from the ONU-specific seed storage 320, the packet-specific seed generator 322, and the byte-specific seed generator 324. In an embodiment, the key generator generates the keys using a fixed conversion function. For example, the seed generator is a hardware-based circuit that performs some XOR scrambling. In an embodiment, the hardware-based circuit is simple enough to be implemented in programmable logic. In an embodiment, an 18-bit key is generated in response to three 16-bit seeds. In an embodiment, the key generator is embodied in an ASIC.

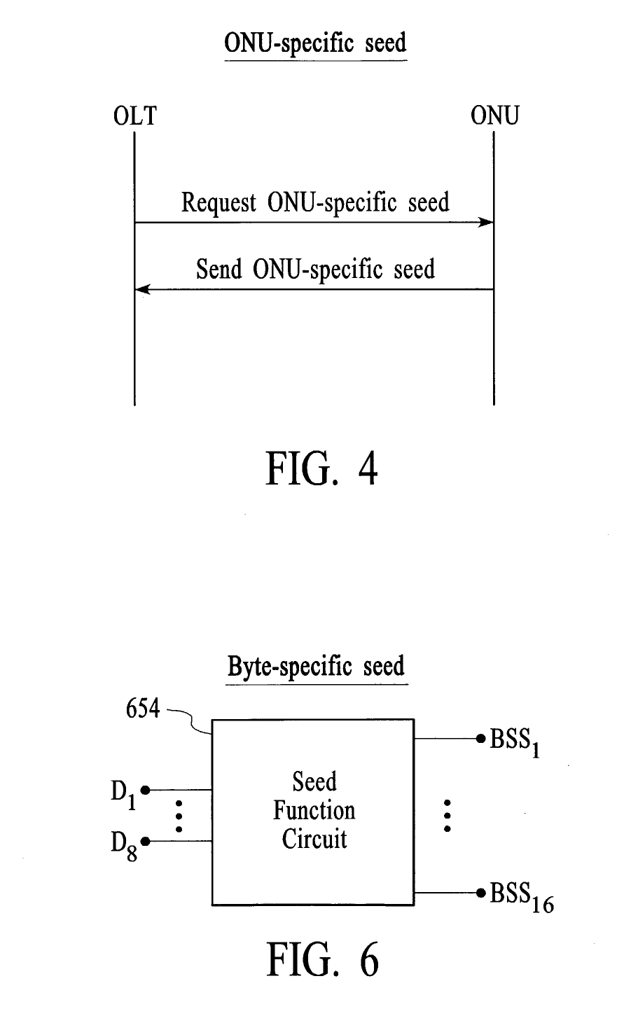

The ONU-specific seed storage 320 stores the ONU-specific seeds that are supplied to the key generator 312. Because there is typically at least one unique seed for each ONU, the ONU-specific seed storage includes memory for storing multiple ONU-specific seeds. The ONU-specific seeds are provided to the key generator based on the intended ONU (or ONUs in a multicast application) of each downstream transmission. In a packet-based point-to-multipoint network, the ONU-specific seeds are provided to the key generator based on the intended ONU of each downstream packet. In an alternative embodiment, the ONU-specific seeds may represent a specific traffic type, such that all traffic of the same type is associated with the same ONU-specific seed even though the traffic is intended for multiple ONUs. In an embodiment, a different ONU-specific seed may be associated with a different VLAN. In an embodiment, the ONU-specific seeds are generated at the ONUs in response to new key requests from the OLT. Newly generated keys are communicated upstream to the OLT and are stored in the ONU-specific seed storage. FIG. 4 depicts an example exchange of ONU-specific seed information between an OLT and an ONU. In particular, when the OLT deems it necessary, a request for a new seed is sent downstream to an ONU (this may be an ONU-specific request or a broadcast or multicast request to multiple ONUs). In response to the request, the ONU sends a new ONU-specific seed upstream to the OLT. In an embodiment, the seed information is exchanged via an in-band channel using, for example, operations and maintenance (OAM) messages. However, the seed information could be exchanged via an out-of-band channel. In an embodiment, initial ONU-specific seed values are established during the provisioning of an ONU or the provisioning of a particular service that is supported by the ONU. The ONU-specific seeds can be changed on a regular basis to improve key randomness. In an embodiment, the ONU-specific seeds are generated at the ONUs and transmitted upstream to the OLT in order to prevent eavesdropping at the other ONUs.

In an embodiment, an ONU-specific seed may be related to more than one ONU. For example, in a multicast application, an ONU-specific seed that is common to more than one ONU may be used to churn and dechurn data. In an embodiment, multicast ONU-specific seeds are generated at the OLT and sent to the ONUs using unicast ONU-specific seeds. That is, the multicast ONU-specific seeds are sent to each ONU using a different ONU-specific seed for each ONU. Because an ONU may belong to more than one multicast group, each ONU may have more than one ONU-specific seed.

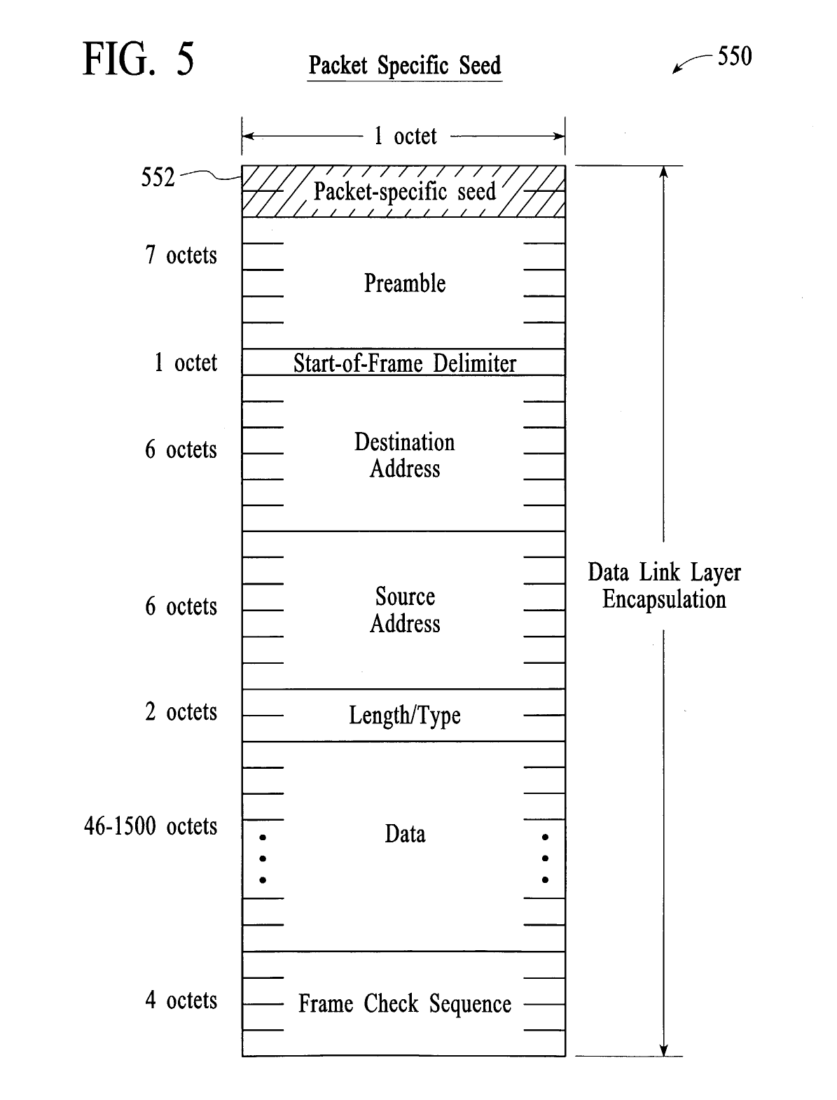

The packet-specific seed generator 322 on the OLT side of the system generates seed values on a per-packet basis for each downstream packet that is to be churned. In an embodiment, the packet-specific seed generator includes a random number generator for generating the seed values. The packet-specific seeds are provided to the key generator 312 on a per-packet basis for key generation. In the embodiment of FIG. 3, the packet-specific seeds are also provided to the transmit logic 328 for incorporation into downstream transmissions. In an embodiment, each packet-specific seed is carried in the downstream packet to which the seed is related. That is, the packet-specific seed that is used to generate the churning key for a particular packet is carried downstream in the churned packet. In an embodiment in which downstream data is formatted according to the IEEE 802.3 frame format (also referred to as “Ethernet”), the packet-specific seed related to a packet may be embedded into the preamble of the related packet. FIG. 5 depicts an example Ethernet packet 550 with a 16-bit packet-specific seed 552 embedded into the preamble. In the example, the packet-specific seed embedded into the preamble is the seed that is used to generate the churning key for the packet on the OLT side of the system and it is the seed that is used to generate the dechurning key for the packet on the ONU side of the system. In an embodiment, the header, or some portion of the header, is not churned so that header information can be read without dechurning. For example, in an embodiment, the preamble is not churned so that the packet-specific seed can be read on the ONU side before dechurning. Although the packet-specific seed depicted in FIG. 5 is embedded into the first two bytes of the preamble, the packet-specific seed could be embedded into other locations within the preamble of the packet. In addition, although the packet-specific seed is described as being embedded into the preamble of the packet to which the seed is related, the packet-specific seed could be transmitted downstream in other ways and with other packets. For example, a packet-specific seed could be carried in the payload of the packet to which it is related or embedded into a different packet (i.e., either a previous or subsequent packet).

Referring back to FIG. 3, the byte-specific seed generator 324 on the OLT side of the system generates seed values on a per-byte basis for each byte of downstream data that is to be churned. In an embodiment, the byte-specific seed generator receives bytes of unchurned downstream data and applies a function to the byte values to generate two byte seeds. That is, one byte of downstream data is used to generate a two byte seed. In an embodiment, the byte-specific seed generator performs a divide by two prime polynomials function on the received downstream data bytes. For example, the byte-specific seed generator may perform a function similar to the cyclical redundancy check (CRC) function that is performed according to the IEE 802.3 protocol. FIG. 6 depicts an example seed function circuit 654 that has an input of one byte of unchurned data and an output of a two byte byte-specific seed. In an embodiment, the byte-specific seed function is reset after each packet. For example, the byte-specific seed function is reset with a known value upon each new packet. In an embodiment, the byte-specific seed generator is embodied in an ASIC.

Referring back to FIG. 3, the seed logic 326 is operationally connected to the ONU-specific seed storage 320, the packet-specific seed generator 322, and the byte-specific seed generator 324, as indicated by the dashed lines 356. The seed logic provides various support functions for each unit. For example, the seed logic provides timing control for the generation of keys and for the supply of keys to the key generator 312. With regard to the ONU-specific seed storage, the seed logic ensures that the proper ONU-specific seeds are provided to the key generator at the proper time. For example, the seed logic ensures that the ONU-specific seeds and the intended ONUs of downstream transmissions are matched. With regard to the packet-specific seed generator, the seed logic ensures that a packet-specific seed is generated for each packet that is to be churned. With regard to the byte-specific seed generator, the seed logic ensures that a packet-specific seed is generated for each byte that is to be churned. Although a separate seed logic element is depicted in the embodiment of FIG. 3, the seed logic may be distributed and incorporated into other units, for example, the byte-specific seed generator, the ONU-specific seed generator, the packet-specific seed generator, and/or the key generator. The seed logic may also be in communication with other elements on the OLT side of the system. The seed logic may be embodied in hardware, software, or any combination thereof.

The transmit logic 328 supports the transmission of downstream packets from the OLT to the ONUs via the optical link 314. The transmit logic may include well-known physical layer (PHY) functions. In addition to the PHY functions, in the embodiment of FIG. 3, the transmit logic may incorporate packet-specific seeds into the preambles of downstream packets as described above with reference to FIG. 5.

ONU Side

With reference to the ONU side of the system, the receive logic 330 controls the receiving of downstream packets at the ONUs. The receive logic may include well-known physical layer (PHY) functions. The receive logic provides churned downstream data to the dechurning logic 332. In addition to the PHY functions, in the embodiment of FIG. 3, the receive logic reads the packet-specific seeds from the packet preambles and provides the packet-specific seeds to the packet-specific seed buffer 340. In an embodiment, the receive logic reads other unchurned header information to make other decisions regarding dechurning. For example, when the ONU has multiple ONU-specific seeds available, information in the unchurned header may be used to select the proper ONU-specific seed for dechurning. For example, a VLAN ID may be used to identify traffic as belonging to a multicast group in which the particular ONU is included.

The dechurning logic 332 performs the dechurning of downstream data. In an embodiment, the dechurning logic performs the dechurning function that is specified in the ITU-T Recommendation G.983.1 as described below with regard to FIGS. 13A-13C. As depicted in FIG. 3, the dechurning logic receives churned downstream data and dechurning keys and outputs dechurned data. In an embodiment, the dechurning logic is embodied in an application specific integrated circuit (ASIC).

The key manager 334 on the ONU side of the system provides the keys to the dechurning logic 332. In an embodiment, the key manager provides a new key to the dechurning logic on a per-word basis. The key manager receives keys from the key generator 336 and may include memory for buffering keys before they are provided to the dechurning logic. As described below, the buffering of keys may be used to implement an offset between key generation and dechurning.

The key generator 336 on the ONU side generates new keys in response to various seeds and is similar to the key generator 312 on the OLT side. In the embodiment of FIG. 3, the key generator generates keys in response to seeds from the ONU-specific seed generator 338, the packet-specific seed buffer 340, and the byte-specific seed generator 342. In an embodiment, the key generator on the ONU side generates the keys using the same technique as the key generator on the OLT side. In an embodiment, the key generators and key managers on the OLT and ONU sides of the network are synchronized so that identical keys are generated for the same byte of data at both the OLT and ONU sides of the system. That is, the same key generation function is used at both sides of the system and the same seeds (i.e., the ONU-specific, the packet-specific, and the word-specific seeds) are used to generate the key for the same byte at both sides of the system. Using this scheme, keys are generated in real-time at both sides of the network using the provided seeds. Generating keys at both sides of the network using seeds eliminates the need to pass keys between the OLT and ONUs, thereby enabling keys to be changed at a higher frequency than when keys are generated at only one side of the network and passed across the network.

The ONU-specific seed generator 338 generates the ONU-specific seeds that are supplied to the key generator 336. In an embodiment, the ONU-specific seed generator includes a random number generator for generating seed values. ONU-specific seeds are generated by the ONU-specific seed generator in response to new key requests from the OLT. The newly generated keys are communicated upstream to the OLT and are stored in the ONU-specific seed storage 320 as described above. As noted above, in the case of multicast groups, ONU-specific seeds may be associated with multiple ONUs and may be generated at the OLT.

The packet-specific seed buffer 340 on the ONU side of the system buffers packet-specific seeds that are obtained from received downstream packets. The packet-specific seeds are provided to the key generator 336 from the buffer on a per-packet basis for key generation. In an embodiment, the packet-specific seeds are obtained from the downstream packets by reading the seed values from the packet preambles as described with reference to FIG. 5. As described above, in an embodiment, each packet-specific seed is carried in the downstream packets to which the seed is related. That is, the packet-specific seed that is used to chum the packet is carried downstream in the same packet. In an embodiment, the packet-specific seed buffer is not necessary because the packet-specific seeds are delivered directly to the key generator or through a different intermediary.

The byte-specific seed generator 342 on the ONU side of the system generates seed values on a per-byte basis for bytes of downstream data that are to be dechurned. In an embodiment, the byte-specific seed generator receives bytes of dechurned downstream data and applies a function to the byte values to generate two byte seed values. In an embodiment, the byte-specific seed generator on the ONU side is similar to the byte-specific seed generator on the OLT side. In an embodiment, the same function is applied by both of the byte-specific seed generators 324 and 342. The two byte seeds that are output from the byte-specific seed generator are used to generate keys that are in turn used to dechurn subsequent bytes of churned downstream data.

The seed logic 344 on the ONU side of the system is operationally connected to the ONU-specific seed generator 338, the packet-specific seed buffer 340, and the byte-specific seed generator 342 as indicated by dashed lines 358. The seed logic on the ONU side of the system is similar to the seed logic on the OLT side of the system and provides various support functions for each unit. For example, the seed logic provides timing control for the generation of keys and for the supply of keys to the key generator. With regard to the ONU-specific seed generator, the seed logic ensures that new ONU-specific seeds are generated in response to new seed requests from the OLT. With regard to the packet-specific seed buffer, the seed logic ensures that the corresponding packet-specific seed is provided to the key generator. With regard to the byte-specific seed generator, the seed logic ensures that a packet-specific seed is generated for each byte that is to be churned. Although a separate seed logic element is depicted in the embodiment of FIG. 3, the seed logic may be distributed and incorporated into other units, for example, the byte-specific seed generator, the ONU-specific seed generator, the packet-specific seed generator, and/or the key generator. The logic may also be in communication with other elements on the ONU side of the system. The seed logic may be embodied in hardware, software, or any combination thereof.

In Operation

In operation, unchurned downstream data is churned at the OLT before being transmitted downstream to the ONUs. The churned data is transmitted downstream via the point-to-multipoint network. The transmitted churned data is received at all of the ONUs and only the ONU, or ONUs, that generate the proper key will be able to dechurn each byte of the churned data into readable plain-text.

With regard to FIG. 3, at the OLT side of the system, unchurned data is provided to the byte-specific seed generator 324 and to the churning logic 316 in byte size words. The byte-specific seed generator generates byte-specific seeds using the unchurned data bytes and provides the byte-specific seeds to the key generator 312. The key generator also receives ONU-specific and packet-specific seeds from the ONU-specific seed storage 320 and the packet-specific seed generator 322, respectively. The ONU-specific seeds are provided to the key generator on a per-ONU basis. That is, the ONU-specific seeds that are supplied to the key generator are related to the ONU to which the respective downstream data is intended. For example, if a packet is intended to ONU-7 (i.e., out of 16 different ONUs), then the ONU-specific seed is related to ONU-7. As described above, the ONU-specific seed related to ONU-7 is preferably generated by ONU-7. The packet-specific seeds are provided to the key generator on a per-packet basis. That is, a new packet-specific seed is supplied to the key generator for each new downstream packet that is to be churned. The packet-specific seeds are supplied to the key generator irrespective of the ONU to which the packet is intended. The byte-specific seeds are generated using bytes of downstream data and are supplied to the key generator on a per-byte basis. Once a byte of data is churned, it is forwarded to the transmit logic. In an embodiment, the transmit logic buffers downstream data until a complete packet is ready. The packet-specific seed that was used to generate the churning keys for the packet is embedded into the packet (i.e., into the preamble) and the packet is transmitted downstream over the point-to-multipoint network.

With each new byte of data that is to be churned, the key generator uses an ONU-specific seed, a packet-specific seed, and a byte-specific seed to generate a new key. The ONU-specific seed changes whenever a packet is intended for a different ONU (or ONU group), the packet-specific seed changes with each new packet, and the byte-specific seed changes with each new byte of downstream data. In this scheme, new keys are generated on a per-ONU, per-packet, and per-byte basis.

In an embodiment, the generation of byte-specific keys from the byte-specific seeds and the churning of bytes using the byte-specific keys are offset by a few bytes. That is, the byte of downstream data that is used to generate a byte-specific seed and ultimately a key is not churned with that key. For example, when a byte (i.e., byte n) in a series of bytes is used to generate a byte-specific seed and ultimately a key (i.e., byte n key) a subsequent byte (i.e., byte n+m, where m represents the offset in bytes) is churned with the key.

At the ONU side of the system, the process of dechurning downstream data is basically the reverse of the churning process. In an embodiment, once a packet is received at the receive logic 330, the packet-specific seed is obtained from the packet and then forwarded to the packet-specific seed buffer 340. In an embodiment, the first few bytes of downstream data may be dechurned using a generic (or reset) byte-specific seed. After a set number of bytes, the byte-specific seed generator 342 generates byte-specific seeds using the dechurned data bytes and provides the byte-specific seeds to the key generator 336. The key generator also receives ONU-specific seeds from the ONU-specific seed generator 338 and packet-specific seeds from the packet-specific seed buffer 340. The ONU-specific seeds that are supplied to the key generator are specific to the ONU. The packet-specific seeds that are provided to the key generator are specific to each packet. That is, a new packet-specific seed is supplied to the key generator for each new downstream packet that is to be dechurned. Once a byte of data is dechurned, the dechurned byte of data is used by the byte-specific seed generator to generate a byte-specific seed.

With each new byte of data that is to be dechurned, the key generator uses an ONU-specific seed, a packet-specific seed, and a byte-specific seed to generate a new key. The ONU-specific seed changes only when the ONU completes an ONU-specific seed change, the packet-specific seed changes with each new packet, and the byte-specific seed changes with each new byte of downstream data. By synchronizing the offset in key generation between the key generators at both sides of the system, the keys that are generated at the ONU side of the system are identical to the keys that are generated at the OLT side of the system.

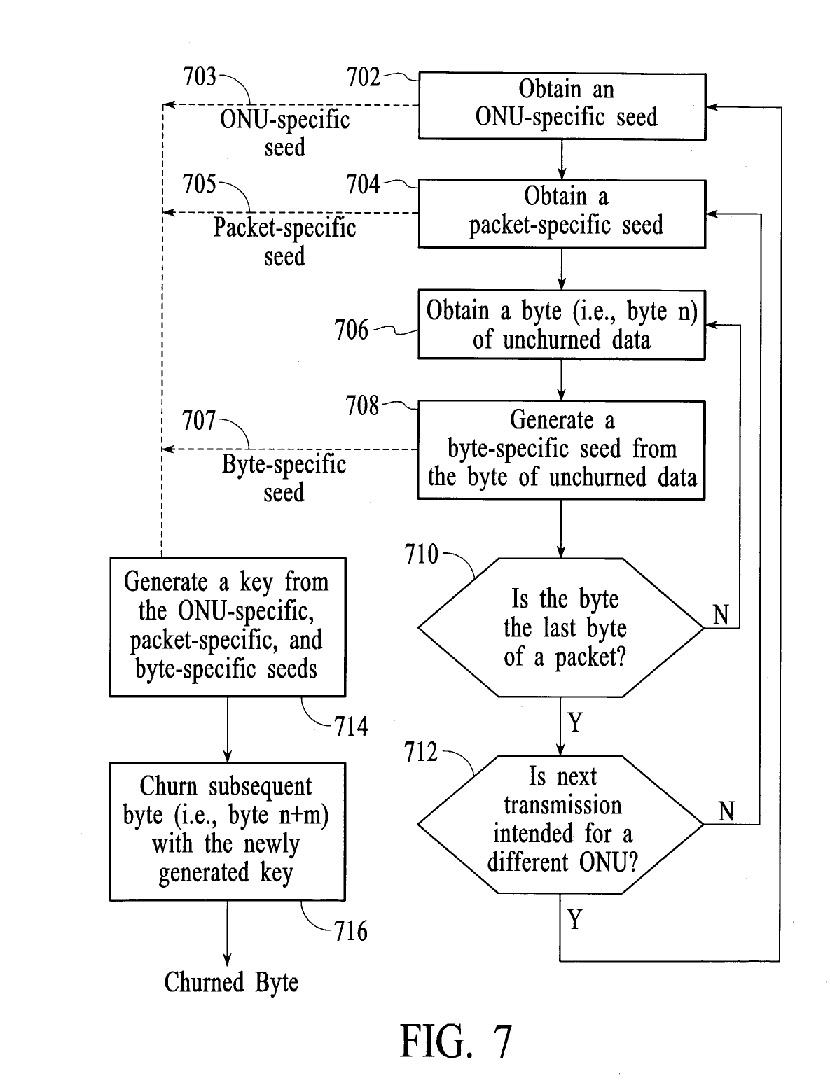

FIG. 7 depicts a process flow diagram of a technique for protecting downstream data transmissions between an OLT and multiple ONUs in a point-to-multipoint network from the perspective of the OLT side (i.e., the churning side) of the network. At block 702, an ONU-specific seed is obtained. For example, the ONU-specific seed is obtained from the ONU to which the downstream transmission is intended. At block 704, a packet-specific seed is obtained. For example, a packet-specific seed is obtained from a packet-specific seed generator. At block 706, a byte (i.e., byte n) of unchurned data is obtained. In the embodiment of FIG. 7, a word size of one byte is used although a different word size could be used. Once the byte of unchurned data is obtained, at block 708, a byte-specific seed is generated from the byte of unchurned data. In an embodiment, a byte-specific seed is generated using a divide by two prime polynomials function, although this is not required. As indicated by dashed lines 703, 705, and 707, the ONU-specific, packet-specific, and byte-specific seeds are provided as inputs to block 714. At block 714, a key is generated from the ONU-specific, packet-specific, and byte-specific seeds. At block 716, a subsequent byte (i.e., byte n+m, where m represents the offset in bytes) is churned with the newly generated key. Returning to decision block 710, if the byte used to generate the byte-specific seed (i.e., byte n) is not the last byte of a packet, then the process returns to block 706, where the next byte of the unchurned data is obtained. If the byte used to generate the byte-specific seed is the last byte of a packet, then the process continues to decision block 712. At decision block 712, it is determined whether the next transmission is intended for a different ONU. If the next transmission is not intended for a different ONU, then the process returns to block 704, where a new packet-specific seed is obtained for the next packet. If the transmission is intended for a different ONU, then the process returns to block 702, where a new ONU-specific seed is obtained.

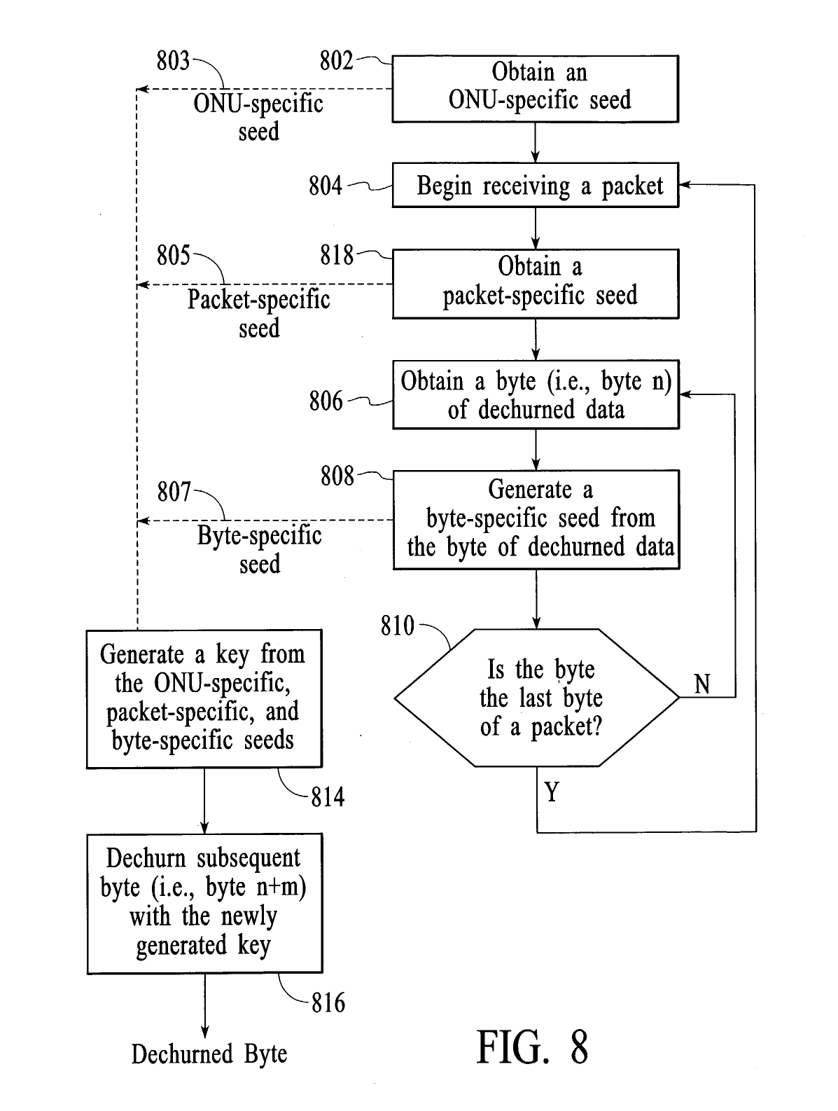

FIG. 8 is a process flow diagram of a technique for protecting downstream data transmissions between an OLT and multiple ONUs in a point-to-multipoint network from the perspective of the ONU side (i.e., the dechurning side) of the network. At block 802, an ONU-specific seed is obtained. For example, the ONU-specific seed is obtained from the ONU-specific seed generator at the ONU of interest. At block 804, the receiving of a packet is begun. At block 818, a packet-specific seed is obtained. For example, a packet-specific seed is obtained from the preamble of the received packet. At block 806, a byte (i.e., byte n) of dechurned data is obtained. Once the byte of dechurned data is obtained, at block 808, a byte-specific seed is generated from the byte of dechurned data. In an embodiment, a byte-specific seed is generated using the same divide by two prime polynomials function as is used at the churning side of the system. As indicated by dashed lines 803, 805, and 807, the ONU-specific, packet-specific, and byte-specific seeds are provided as inputs to block 814. At block 814, a key is generated from the ONU-specific, packet-specific, and byte-specific seeds. At block 816, a subsequent byte (i.e., byte n+m, where m represents the offset in bytes) is dechurned with the newly generated key. Returning to decision block 810, if the byte used to generate the byte-specific seed is not the last byte of a packet, then the process returns to block 806, where the next byte of the dechurned data is obtained. If the byte used to generate the byte-specific seed is the last byte of a packet, then the process returns to block 804 where a new packet is received.

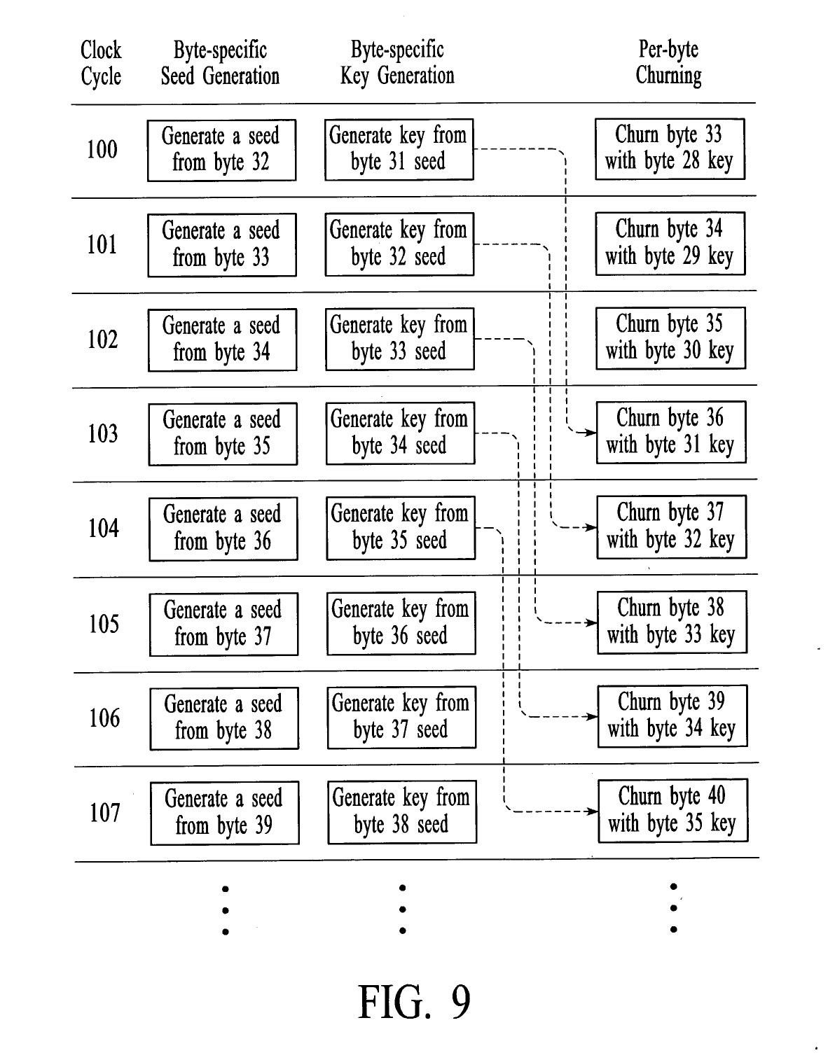

FIG. 9 depicts an example sequence of per-byte processes from the perspective of the OLT side (i.e., the churning side) of a point-to-multipoint network. The depicted processes include byte-specific seed generation (i.e., as performed by the byte-specific seed generator), byte-specific key generation (i.e., as performed by the key generator), and per-byte churning (i.e., as performed by the churning logic). As depicted in FIG. 9, the processes are performed in parallel. That is, the processes of generating a byte-specific seed, generating a byte-specific key, and churning a byte of data occur every clock cycle. The example sequence covers a sequence of bytes that arrive in ascending order (i.e., byte-28 is received one clock cycle before byte-29) over a period of eight clock cycles. As described above, in an embodiment, there is an offset between the generation of seeds and keys and the churning of bytes with the generated keys. FIG. 9 depicts an example of the offset between the generation of seeds and keys and the churning of bytes with the generated keys. Referring to clock cycle 100, a seed is generated from byte 32. At clock cycle 101, a key is generated from the byte 32 seed. That is, the seed that was generated from byte 32 is used in the next clock cycle to generate a key (referred to as the byte 32 key). In an embodiment, the key is generated using an ONU-specific seed, a packet-specific seed, and a byte-specific seed as described above. Skipping down to clock cycle 104, byte 37 is churned with the byte 32 key that was generated at clock cycle 101. That is, the previously generated byte 32 key is input into the churning logic to churn byte 37. In the example depicted in FIG. 9, there is an offset of three clock cycles (i.e., m=3) between the time when a byte-specific key is generated and the time when the key is used to churn a byte of downstream data. The dashed lines between key generation and churning indicates the offset. The processes of generating byte-specific seeds, generating byte-specific keys, and per-byte churning continue as depicted in FIG. 9 and the offset (in clock cycles) between key generation and the use of the keys for churning remains constant.

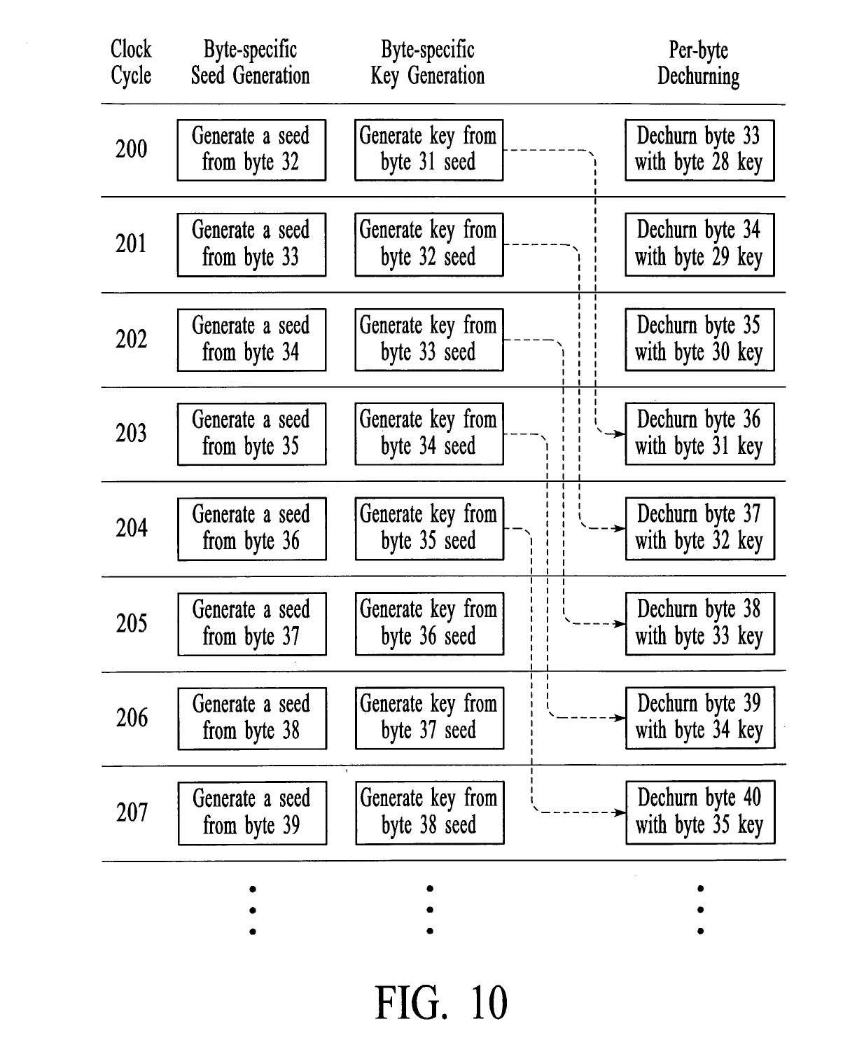

The sequence of per-byte processes at the ONU side of the network is similar to the OLT side of the network. FIG. 10 depicts an example sequence of per-byte processes from the perspective of the ONU side (i.e., the dechurning side) of a point-to-multipoint network. The depicted processes include byte-specific seed generation (i.e., as performed by the byte-specific seed generator), byte-specific key generation (i.e., as performed by the key generator), and per-byte dechurning (i.e., as performed by the dechurning logic). The example sequence covers a sequence of bytes that are received in ascending order (i.e., byte 28 is received one clock cycle before byte 29) over a period of eight clock cycles. In the example of FIG. 10, the offset between the generation of seeds and keys and the dechurning of bytes with the generated keys is the same as the offset depicted in FIG. 9. Referring to clock cycle 200, a seed is generated from byte 32. In the example, it is assumed that byte 32 has been previously dechurned. At clock cycle 201, a key is generated from the byte 32 seed. That is, the seed that was generated from byte 32 is used in the next clock cycle to generate a key (referred to as the byte 32 key). In an embodiment, the key is generated using an ONU-specific seed, a packet-specific seed, and a byte-specific seed as described above. Skipping down to clock cycle 204, byte 37 is dechurned with the byte 32 key that was generated at clock cycle 201. That is, the byte 32 key is input into the dechurning logic to dechurn byte 37. In the example of FIG. 10, the offset is the same as in the example of FIG. 9. At clock 205, a seed is generated from the dechurned byte 37. Note that in the above-described example, an offset between seed generation and dechurning is required because a seed cannot be generated from a byte of downstream data until the byte of downstream data has been dechurned. That is, a seed cannot be generated from byte 38 until after byte 38 has been dechurned. The process continues as depicted in FIG. 10 and the offset (in clock cycles) between key generation and use of the keys for dechurning remains constant.

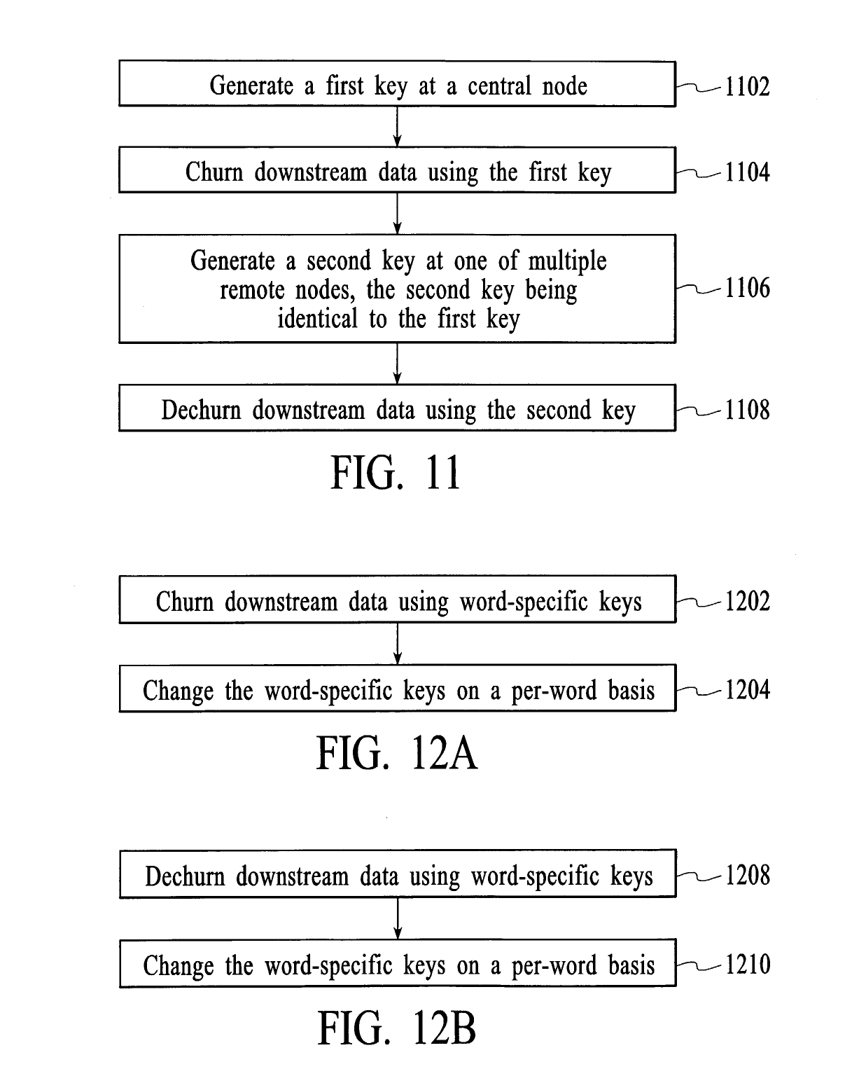

FIG. 11 depicts a process flow diagram of a method for protecting data transmissions between a central node and multiple remote nodes in a point-to-multipoint network. At block 1102, a first key is generated at the central node. At block 1104, downstream data is churned using the first key. At block 1106, a second key is generated at one the multiple remote nodes, the second key being identical to the first key. At block 1108, downstream data is dechurned using the second key.

FIG. 12A depicts another process flow diagram of a method for protecting data transmissions between a central node and multiple remote nodes in a point-to-multipoint network. At block 1202, downstream data is churned using word-specific keys. At block 1204, the word-specific keys are changed on a per-word basis.

FIG. 12B depicts another process flow diagram of a method for protecting data transmissions between a central node and multiple remote nodes in a point-to-multipoint network. At block 1208, downstream data is dechurned using word-specific keys. At block 1210, the word-specific keys are changed on a per-word basis.

In the above-described embodiment, the churning and dechurning keys are generated in response to the three seeds (i.e., the ONU-specific, packet-specific, and byte-specific seeds). However, it should be noted that keys could be generated in response to a subset of the above-described seeds. For example, the keys could be generated in response to the byte-specific seeds only or in response to byte-specific and ONU-specific seeds.

Although for example purposes, churning, dechurning, and key generation is described on a per-byte basis, the word size of one byte is purely for example purposes. A word size of other than one byte could be used. Throughout the description, the terms key, churn key, and churning key are used synonymously.

Throughout the description, the point-to-multipoint network is described as a PON, although the technique for protecting downstream data transmissions could be applied to other point-to-multipoint networks including optical, wire-line, and wireless point-to-multipoint networks. In addition, although OLTs are described as the central node in a PON application, the central node may be described using different terminology in different network architectures. Likewise, although ONUs are described as the remote nodes in a PON application, the remote nodes may be described using different terminology in different network architectures.

In an embodiment, the technique for protecting downstream data transmissions is applied in an Ethernet-based point-to-multipoint network although it could be applied in a point-to-multipoint network that uses a protocol other that Ethernet, for example, ATM.

Although in the description, 16-bit seeds and 18-bit keys are described, the bit-length of the seeds and keys is implementation specific and may be different in other implementations.

Although the term “packet” is used to describe the packet-specific seeds, the term packet is understood to include any known frame structure. In particular, the term packet includes variable-length Ethernet packets and fixed-length ATM cells.

FIGS. 13A-13C depict the churning and dechurning logic that is described by the ITU-T in the Recommendation G.983.1. FIG. 13A depicts the churn logic on the OLT side of a point-to-multipoint network, FIG. 13B depicts the dechurn logic on the ONU side of the point-to-multipoint network, and FIG. 13C depicts an expanded view of the churn/dechurn functional blocks that are depicted in FIGS. 13A and 13B. According to the Recommendation G.983.1, the keys start as three byte codes that are defined as X1-X8, and P1-P16. The three byte codes are used to generate K1-K10 bits.

The K1 and K2 bits are generated by X1˜X8, P13˜P15 and P16 in ONU and OLT respectively. The generation method is as follows:

K1=(X1*P13*P14)+(X2*P13*notP14)+(X7*notP13*P14)+(X8*notP13*notP14)

K2=(X3*P15*P16)+(X4*P15*notP16)+(X5*notP15*P16)+(X6*notP15*notP16)

+: logical OR *: logical AND not: logical NOT

The K3-K10 bits are generated by K1, K2, P9-P11 and P12 in ONU and OLT. The generation method is as follows:

K3=(K1*P9)+(K2*notP9)

K4=(K1*notP9)+(K2*P9)

K5=(K1*P10)+(K2*notP10)

K6=(K1*notP10)+(K2*P10)

K7=(K1*P11)+(K2*notP11)

K8=(K1*notP11)+(K2*P11)

K9=(K1*P12)+(K2*notP12)

K10=(K1*notP12)+(K2*P12)

Downstream user data is churned based on 18 bit codes in the OLT. These codes, K1, K2, P1˜P11 and P12 are used for churning. FIG. 13A shows an example configuration of the churn function in OLT.

Received user data is dechurned based on 18 bit codes in ONU. These codes, K1, K2, P1˜P11 and P12 are also used for churning. FIG. 13B also shows an example configuration of the dechurn function in ONU.

Although specific embodiments in accordance with the invention have been described and illustrated, the invention is not limited to the specific forms and arrangements of parts so described and illustrated. The invention is limited only by the claims.

What is claimed is:

1. A method for protecting data transmissions between a central node and multiple remote nodes in a point-to-multipoint network comprising:
generating a first key at said central node;
churning downstream data using said first key;
generating a second key at one of said multiple remote nodes, said second key being identical to said first key; and
dechurning downstream data using said second key.

2. The method of claim 1 further including:
generating a word-specific seed from unchurned downstream data;
using said word-specific seed to generate said first key;
generating a word-specific seed from dechurned downstream data; and
using said word-specific seed to generate said second key.

3. The method of claim 2 further including generating said word-specific seeds on a per-word basis.

4. The method of claim 2 further including:
changing said first key on a per-word basis; and
changing said second key on a per-word basis.

5. The method of claim 1 further including:
passing a first seed from said one remote node to said central node;
using said first seed to generate said first key and said second key;
passing a second seed from said central node to said one remote node; and
using said second seed to generate said first key and said second key.

6. The method of claim 5 wherein said first seed is a remote node-specific seed that is specific to said one remote node and said second seed is a packet-specific seed that is specific to a downstream packet.

7. The method of claim 6 wherein said second seed is changed on a per-packet basis.

8. A method for protecting downstream data transmissions between a central node and multiple remote nodes in a point-to-multipoint network comprising:
churning downstream data using word-specific keys; and
changing said word-specific keys on a per-word basis.

9. The method of claim 8 wherein changing said word-specific keys on a per-word basis includes generating said word-specific keys in response to data words of said downstream data.

10. The method of claim 8 further including:
transmitting churned downstream data to said multiple remote nodes;
at at least one of said multiple remote nodes, generating word-specific keys;
dechurning said downstream data using said word-specific keys; and
changing said word-specific keys on a per-word basis.

11. The method of claim 8 further including;
churning downstream data using word-specific and remote node-specific keys; and
changing said word-specific and remote node-specific keys on a per-word and per-remote node basis.

12. The method of claim 11 further including:
transmitting churned downstream data to said multiple remote nodes;
at at least one of said multiple remote nodes, generating word-specific and remote node-specific keys;
dechurning said downstream data using said word-specific and remote node-specific keys; and
changing said word-specific and remote node-specific keys on a per-word basis.

13. The method of claim 8 further including;
churning downstream data using word-specific, remote node-specific, and packet-specific keys; and
changing said word-specific, remote node-specific, and packet-specific keys on a per-word, per-remote node, and per-packet basis.

14. The method of claim 13 further including:
transmitting churned downstream data to said multiple remote nodes;
at at least one of said multiple remote nodes, generating word-specific, remote node-specific, and packet-specific keys;
dechurning said downstream data using said word-specific, remote node-specific, and packet-specific keys; and
changing said word-specific, remote node-specific, and packet-specific keys on a per-word per-packet basis.

15. The method of claim 13 further including generating each one of said word-specific, remote node-specific, and packet-specific keys from a word-specific seed, a remote node-specific seed, and a packet-specific seed, respectively.

16. The method of claim 15 further including generating remote node-specific seeds at said remote nodes and transmitting said remote node-specific seeds upstream to said central node.

17. The method of claim 16 further including generating packet-specific seeds at said central node and embedding said packet-specific seeds into downstream packets to which said packet-specific seeds correspond.

18. The method of claim 17 further including embedding packet-specific seeds into the preambles of downstream packets.

19. The method of claim 17 further including generating said word-specific seeds in response to data words of said downstream data.

20. The method of claim 8 wherein a word consists of 8 bits.

21. The method of claim 8 wherein said central node is an optical line terminal (OLT) and wherein said remote nodes are optical network units (ONUs).

22. The method of claim 8 wherein downstream data is transmitted in variable-length packets formatted according to IEEE 802.3.

23. The method of claim 8 wherein said downstream data is churned as defined in the ITU-T Recommendation G.983.1.

24. A method for protecting downstream data transmissions between a central node and multiple remote nodes in a point-to-multipoint network comprising:
dechurning downstream data using word-specific keys; and
changing said word-specific keys on a per-word basis.

25. The method of claim 24 wherein changing said word-specific keys on a per-word basis includes generating said word-specific keys in response to data words of said downstream data.

26. The method of claim 24 further including;
dechurning downstream data using word-specific and remote node-specific keys; and
changing said word-specific and remote node-specific keys on a per-word and per-remote node basis.

27. The method of claim 24 further including;
dechurning downstream data using word-specific, remote node-specific, and packet-specific keys; and
changing said word-specific, remote node-specific, and packet-specific keys on a per-word, per-remote node, and per-packet basis.

28. The method of claim 27 further including generating each one of said word-specific, remote node-specific, and packet-specific keys from a word-specific seed, a remote node-specific seed, and a packet-specific seed, respectively.

29. The method of claim 28 further including generating remote node-specific seeds at said remote nodes and transmitting said remote node-specific seeds upstream to said central node.

30. The method of claim 28 further including obtaining said packet-specific seeds from the preambles of downstream packets.

31. A method for generating keys that are used to churn and dechurn downstream data between an optical line terminal (OLT) and multiple optical network units (ONUs) in a point-to-multipoint packet-based network comprising:
obtaining an ONU-specific seed that uniquely identifies one of said multiple ONUs;
obtaining a word-specific seed that is generated in response to a word of said downstream data; and
generating a key for a particular word of said downstream data in response to said ONU-specific seed and said word-specific seed.

32. The method of claim 31 further including generating a new key on a per-word basis using word-specific seeds that are generated in response to words of said downstream data.

33. The method of claim 31 further including
obtaining a packet-specific seed that corresponds to a downstream packet that is to be churned; and
generating a churning key for a particular word of said downstream data in response to said ONU-specific seed, said word-specific seed, and said packet-specific seed.

34. The method of claim 31 further including;
generating ONU-specific seeds at said ONUs; and
transmitting ONU-specific seeds upstream from said ONUs to said OLT.

35. The method of claim 31 further including generating said packet-specific seeds at said OLT.

36. A method for protecting downstream data transmissions between an optical line terminal (OLT) and multiple optical network units (ONUS) in a point-to-multipoint optical network comprising:
obtaining at least one of a word-specific seed, a packet-specific seed, and an ONU-specific seed;
generating a key at said OLT using said obtained at least one key; and
churning downstream data using said key.

37. The method of claim 36 further including changing said key on a per-word, per-remote node, and per-packet basis.

38. The method of claim 36 further including transmitting said churned downstream data to said multiple ONUs.

39. The method of claim 36 further including generating said key again at one of said ONUs, and dechurning said downstream data using said key that is generated at said one of said ONUs.

40. A method for protecting downstream data transmissions between an optical line terminal (OLT) and multiple optical network units (ONUs) in a point-to-multipoint network comprising:
generating ONU-specific and word-specific keys;
churning downstream data using said ONU-specific and word-specific keys; and
changing said ONU-specific and word-specific keys on a per-ONU and per-word basis.

41. The method of claim 40 further including generating each one of said word-specific and remote node-specific keys from a word-specific seed a remote node-specific seed.

42. The method of claim 40 wherein:
generating ONU-specific and word-specific keys includes generating ONU-specific, word-specific, and packet-specific keys;
churning downstream data using said ONU-specific and word-specific keys includes churning downstream data using said ONU-specific, word-specific, and packet-specific keys; and
changing said ONU-specific and word-specific keys on a per-ONU and per-word basis includes changing said ONU-specific, word-specific, and packet-specific keys on a per-ONU, per-word, and per-packet basis.

43. The method of claim 42 further including generating each one of said ONU-specific, word-specific, and packet-specific keys from an ONU-specific seed, a word-specific seed, and a packet-specific seed.

44. A system for protecting downstream data transmitted from a central node to multiple remote nodes in a point-to-multipoint network comprising:
churning logic for churning downstream data, said churning logic being responsive to a key; and
means, operatively associated with said churning logic, for supplying word-specific keys to said churning logic on a per-word basis.

45. The system of claim 44 wherein said means for supplying word-specific keys includes a key generator that generates word-specific keys in response to word-specific seeds.

46. The system of claim 45 wherein said means for supplying word-specific keys further includes a word-specific seed generator that generates word-specific seeds in response to words of unchurned downstream data.

47. The system of claim 45 wherein said means for supplying word-specific keys to said churning logic includes a key manager for providing said word-specific keys to said churning logic on a per-word basis.

48. The system of claim 44 further including:
at said central node, transmit logic for transmitting churned downstream data to said multiple remote nodes;
at each of said multiple remote nodes;
receive logic for receiving said churned downstream data from said central node;
dechurning logic for dechurning said churned downstream data, said churning logic being responsive to a key;
means, operatively associated with said dechurning logic, for supplying word-specific keys to said dechurning logic on a per-word basis.

49. The system of claim 44 wherein said means for supplying word-specific keys includes means for supplying word-specific and remote node-specific keys to said dechurning logic on a per-word and per-remote node basis.

50. The system of claim 49 wherein said means for supplying word-specific and remote node-specific keys includes a key generator that generates word-specific and remote node-specific keys in response to word-specific seeds and remote node-specific seeds.

51. The system of claim 50 wherein said means for supplying word-specific and remote node-specific keys further includes a word-specific seed generator that generates word-specific seeds in response to words of unchurned downstream data and remote node-specific seed storage that supplies remote node-specific seeds to said key generator.

52. The system of claim 51 further including:
at said central node, transmit logic for transmitting churned downstream data to said multiple remote nodes;
at each of said multiple remote nodes;
receive logic for receiving said churned downstream data from said central node;
dechurning logic for dechurning said churned downstream data, said churning logic being responsive to a key;
means, operatively associated with said dechurning logic, for supplying word-specific and remote node-specific keys to said dechurning logic on a per-word and per-remote node basis.

53. The system of claim 44 wherein said means for supplying word-specific keys includes means for supplying word-specific, remote node-specific, and packet-specific keys to said churning logic on a per-word, per-remote node, and per-packet basis.

54. The system of claim 53 wherein said means for supplying word-specific, remote node-specific, and packet-specific keys includes a key generator that generates word-specific, remote node-specific, and packet-specific keys in response to word-specific, remote node-specific, and packet-specific seeds.

55. The system of claim 54 wherein said means for supplying word-specific, remote node-specific, and packet-specific keys further includes a word-specific seed generator that generates word-specific seeds in response to words of dechurned downstream data, remote node-specific seed storage that supplies remote node-specific seeds to said key generator, and a packet-specific seed generator that generates packet-specific seeds on a per-packet basis.

56. The system of claim 55 further including:
at said central node, transmit logic for transmitting churned downstream data to said multiple remote nodes;
at each of said multiple remote nodes;
receive logic for receiving said churned downstream data from said central node;
dechurning logic for dechurning said churned downstream data, said churning logic being responsive to a key;
means, operatively associated with said dechurning logic, for supplying word-specific, remote node-specific, and packet-specific keys to said dechurning logic on a per-word, per-remote node, and per-packet basis.

57. A system for protecting downstream data transmitted from a central node to multiple remote nodes in a point-to-multipoint network comprising:
dechurning logic for dechurning downstream data, said dechurning logic being responsive to a key; and
means, operatively associated with said dechurning logic, for supplying word-specific keys to said dechurning logic on a per-word basis.

58. The system of claim 57 wherein said means for supplying word-specific keys includes a key generator that generates word-specific keys in response to word-specific seeds.

59. The system of claim 58 wherein said means for supplying word-specific keys further includes a word-specific seed generator that generates word-specific seeds in response to words of unchurned downstream data.

60. The system of claim 58 wherein said means for supplying word-specific keys to said churning logic includes a key manager for providing said word-specific keys to said churning logic on a per-word basis.

61. The system of claim 57 wherein said means for supplying word-specific keys includes means for supplying word-specific and remote node-specific keys to said churning logic on a per-word and per-remote node basis.

62. The system of claim 57 wherein said means for supplying word-specific keys includes means for supplying word-specific, remote node-specific, and packet-specific keys to said churning logic on a per-word, per-remote node, and per-packet basis.

63. A system for protecting downstream data transmitted from a central node to multiple remote nodes in a point-to-multipoint network comprising:
at said central node;
remote node-specific seed storage for storing remote node-specific seeds;
a packet-specific seed generator for generating packet-specific seeds on a per-packet basis;
a word-specific seed generator for generating word-specific seeds in response to words of unchurned downstream data;
a key generator for generating remote node-specific, packet-specific, and word-specific keys in response to remote node-specific seeds from said remote node-specific seed storage, packet-specific seeds from said packet-specific seed generator, and word-specific seeds from said word-specific seed generator;
churning logic for churning downstream data in response to remote node-specific, packet-specific, and word-specific keys from said key generator;
at each of said multiple remote nodes;
a remote node-specific seed generator for generating remote node-specific seeds;
a word-specific seed generator for generating word-specific seeds in response to words of dechurned downstream data;
a key generator for generating remote node-specific, packet-specific, and word-specific keys in response to remote node-specific seeds from said remote node-specific seed storage, packet-specific seeds, and word-specific seeds from said word-specific seed generator; and
dechurning logic for dechurning churned downstream data in response to remote node-specific, packet-specific, and word-specific keys from said key generator.

64. The system of claim 63 wherein said central node includes transmit logic for embedding said packet-specific seeds into downstream packets and wherein each of said multiple remote nodes includes receive logic for obtaining said packet-specific seeds from said downstream packets and for supplying said packet-specific seeds to said key generator at the respective remote nodes.

65. The system of claim 64 wherein each of said multiple remote nodes includes a packet-specific seed buffer connected to receive said packet-specific seeds from said receive logic and to supply said packet-specific seeds to said key generator.

66. A system for protecting downstream data transmitted from a central node to multiple remote nodes in a point-to-multipoint network comprising:
at said central node;
a key generator for generating keys in response to key seeds;
churning logic for churning downstream data in response to keys from said key generator;
at each of said multiple remote nodes;
a key generator for generating keys in response to key seeds; and
dechurning logic for dechurning churned downstream data in response to keys from said key generator.

67. The system of claim 66 further including a word-specific seed generator, at said central node, for generating word-specific seeds in response to words of unchurned downstream data and a word-specific seed generator, at each of said multiple remote nodes, for generating word-specific seeds in response to words of dechurned downstream data.

68. The system of claim 66 further including remote node-specific seed storage, at said central node, for storing remote node-specific seeds and a remote node-specific seed generator, at each of said multiple remote nodes, for generating remote node-specific seeds.

69. The system of claim 66 wherein said central node includes a packet-specific seed generator for generating packet-specific seeds on a per-packet basis and transmit logic for embedding said packet-specific seeds into downstream packets and wherein each of said multiple remote nodes includes receive logic for obtaining said packet-specific seeds from said downstream packets and for supplying said packet-specific seeds to said key generator at the respective remote nodes.

70. The system of claim 69 wherein each of said multiple remote nodes includes a packet-specific seed buffer connected to receive said packet-specific seeds from said receive logic and to supply said packet-specific seeds to said key generator.
